(19) United States
(12) Patent Application Publication
(10) Pub. No.: US 2024/0011847 A1
(43) Pub. Date: Jan. 11, 2024

(54) ANOMALY DETECTION AND ADAPTIVE THERMAL CONTROL FOR AN ELECTRICAL ASSET

(71) Applicant: Eaton Intelligent Power Limited, Dublin (IE)

(72) Inventors: Bubathi Muruganantham, Pune (IN); Prasad Arvind Venikar, Pune (IN); Balachandar D, Madurai (IN); Mugdha Vyankatesh Limaye, Pune (IN); Mark Andre Faulkner, Greenwood, SC (US); Travis Vernon Spoone, Greenwood, SC (US); Robert Edward Page, Indianapolis, IN (US); Antonio Romero Oruga, Greenwood, SC (US); Swetha Prakash, Palakkad (IN)

(21) Appl. No.: 18/216,673

(22) Filed: Jun. 30, 2023

Related U.S. Application Data
(60) Provisional application No. 63/358,632, filed on Jul. 6, 2022.

(51) Int. Cl. G01K 7/42; G01K 1/20

(52) U.S. Cl. CPC G01K 7/427; G01K 1/20

(57) ABSTRACT

An electrical apparatus includes: a housing that defines an interior space; an active portion in the interior space, the active portion including one or more electrically conductive coils; a fluid in the interior; and a control system configured to: determine a difference between a measured temperature of the fluid and an estimated temperature of the fluid; and determine whether a performance condition exists based on the difference.

### CROSS-REFERENCE TO RELATED APPLICATION

This application claims the benefit of U.S. Provisional Application No. 63/358,632, filed on Jul. 6, 2022 and titled ANOMALY DETECTION AND ADAPTIVE THERMAL CONTROL FOR AN ELECTRICAL ASSET, which is incorporated herein by reference in its entirety.

### TECHNICAL FIELD

This disclosure relates to anomaly detection and adaptive thermal control of an electrical asset. The electrical asset may be, for example, a transformer.

### BACKGROUND

An electrical asset, such as transformer, may be used as part of an electrical system that distributes time-varying or alternating current (AC) electrical power. The electrical system may include other electrical assets, such as, for example, voltage regulators, inductors, transmission lines, and switches.

### SUMMARY

In one aspect, an electrical apparatus includes: a housing that defines an interior space; an active portion in the interior space, the active portion including one or more electrically conductive coils; a fluid in the interior; and a control system configured to: determine a difference between a measured temperature of the fluid and an estimated temperature of the fluid; and determine whether a performance condition exists based on the difference.

Implementations may include one or more of the following features.

To determine whether a performance condition exists, the control system may be configured to compare the difference to a threshold. The control system may determine that a performance condition exists when an absolute value of the difference is equal to or exceeds the threshold.

The electrical apparatus also may include a temperature sensor configured to measure the temperature of the fluid.

The electrical apparatus also may include a cooling system configured to circulate the fluid in the interior space. The cooling system may include an inlet and an outlet, the temperature sensor may be configured to measure the temperature of the fluid at the inlet, and the estimated temperature of the fluid may be an estimated temperature of the fluid at the inlet.

Each of the one or more coils may be wrapped around a magnetic core. Each of the one or more coils may be wrapped around a separate magnetic core.

In another aspect, an electrical apparatus includes: a housing that defines an interior space; an active portion in the interior space, the active portion including one or more electrically conductive coils; a cooling system configured to remove heat from the active portion; and a control system configured to: predict a future temperature in the interior space based on a load forecast; and determine whether to control the cooling system based on the future temperature.

Implementations may include one or more of the following features.

The electrical apparatus also may include a fluid in the interior space, and the cooling system may be configured to control the fluid to thereby remove heat from the active portion.

The cooling system may include one or more devices configured to cause the fluid to move in the interior space.

The cooling system may include an inlet and an outlet, the fluid may be configured to flow into the interior space through the inlet, and the fluid may be configured to flow out of the interior space through the outlet.

The load forecast may include a load factor and a time during which the load factor occurs. The control system may be configured to control the control system by activating the cooling system or to deactivating the control system. The control system may be further configured to compare the future temperature to a temperature specification. The control system may activate the cooling system if the future temperature exceeds the temperature specification. In some implementations, the control system determines a time at which to activate the cooling system if the future temperature exceeds the temperature specification.

Implementations of any of the techniques described herein may be a system, a method, or executable instructions stored on a machine-readable medium. The details of one or more implementations are set forth in the accompanying drawings and the description below. Other features will be apparent from the description and drawings, and from the claims.

### DRAWING DESCRIPTION

FIG. 1 is a block diagram of an example of a system.

FIG. 2 is a block diagram of another example of a system.

FIG. 3 is a block diagram of an example of a monitoring scheme.

FIG. 4 is a flow chart of an example of a process for determining the overload capability of an electrical asset.

FIG. 5 shows predicted hotspot temperature in Celsius (° C.) as a function of time in hours for each of a range of load factors for a simulated transformer.

FIG. 6 is a contour plot of predicted overload capability for the same simulated transformer as FIG. 5, with time (minutes) versus load factor, with the contour lines being the predicted hotspot temperature in ° C.

FIG. 7 is a flow chart of an example of a process for adaptively controlling a thermal management system.

FIG. 8 shows simulated a simulated load forecast.

FIG. 9A shows simulated per-unit (pu) load as a function of time.

FIG. 9B shows estimated hotspot temperature as a function of time.

FIG. 10 is a flow chart of an example of an anomaly detection process for detecting error conditions in an electrical apparatus based on thermal data.

### DETAILED DESCRIPTION

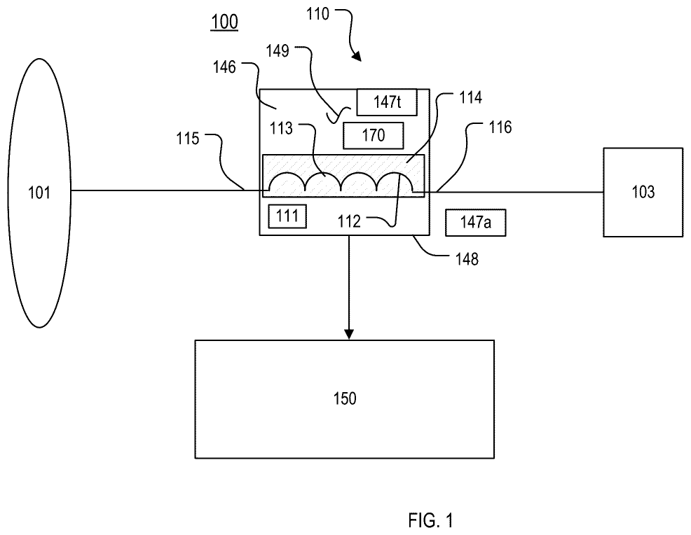

FIG. 1 is a block diagram of an example of a system 100 that includes an alternating current (AC) electrical power grid 101. A single phase is shown in FIG. 1 for simplicity. However, the power system 100 may be a multi-phase (for example, three-phase) power system. The electrical power system 100 includes an electrical asset 110 and a monitoring system 150. As discussed below, the monitoring system 150 allows efficient operation of the electrical asset 110. For example, the monitoring system 150 monitors the electrical asset 110 to perform thermal-based anomaly detection to predict malfunctions in the electrical asset 110. Additionally or alternatively, the monitoring system 150 adaptively controls a thermal management system 170 that is part of the electrical asset 110.

The electrical asset 110 is any type of electrical equipment that is configured for use in an AC electrical power system. For example, the electrical asset 110 may be a transformer, a voltage regulator, or an inductor. The electrical asset 110 may be a three-phase electrical asset. The electrical asset 110 may include one or more electrically conductive windings or coils.

The electrical asset 110 has a rated load, which is determined from the nominal voltage output of the electrical asset 110 at the maximum deliverable current that the electrical asset 110 is designed to conduct. The rated load may be expressed in units of volt-amperes (VA). The rated load may be included on a nameplate 111 of the electrical asset 110 and/or otherwise associated with the electrical asset 110. The electrical asset 110 is overloaded when the rated load is exceeded. The amount of overloading may be characterized relative to the rated load using a load factor, which is the ratio of the present load to the rated load. For example, operating the electrical asset 110 at the rated load is a load factor of 1, and operating the electrical asset such that it operates at a volt-ampere amount that is 10% greater than the rated load is a load factor of 1.1. Uncontrolled overloading of the electrical asset 110 may result in accelerated aging of the electrical asset 110. For example, overloading may affect the thermal performance of the electrical asset 110 and lead to component failure or cause the electrical asset 110 to fail prior to its expected lifetime. Thus, legacy systems tend to be operated in a manner that avoids overloading.

As discussed in greater detail below, the monitoring system 150 is configured to adaptively control the thermal conditions of the electrical asset 110 based on actual loading and/or a forecasted future load factor instead of relying on assumed or default loading. The adaptive control prolongs the life of the electrical asset 110 and conserves resources. Alternatively or additionally, the monitoring system 150 is configured to detect performance anomalies using thermal data to identify and/or predict malfunctions in the electrical asset 110. Identifying and/or predicting malfunctions in the electrical asset 110 allows repair of the electrical asset 110, thereby extending the life of the electrical asset 110.

Before discussing the monitoring system 150 in greater detail, an overview of the AC power grid 101 and the electrical asset 110 is provided.

The AC power grid 101 is a three-phase power grid that operates at a fundamental frequency of, for example, 50 or 60 Hertz (Hz). The power grid 101 includes devices, systems, and components that transfer, distribute, generate, and/or absorb electricity. For example, the power grid 101 may include, without limitation, generators, power plants, electrical substations, transformers, renewable energy sources, transmission lines, reclosers and switchgear, fuses, surge arrestors, combinations of such devices, and any other device used to transfer or distribute electricity.

The power grid 101 may be low-voltage (for example, up to 1 kilovolt (kV)), medium-voltage or distribution voltage (for example, between 1 kV and 35 kV), or high-voltage (for example, 35 kV and greater). The power grid 101 may include more than one sub-grid or portion. For example, the power grid 101 may include AC micro-grids, AC area networks, or AC spot networks that serve particular customers. These sub-grids may be connected to each other via switches and/or other devices to form the grid 101. Moreover, sub-grids within the grid 101 may have different nominal voltages. For example, the grid 101 may include a medium-voltage portion connected to a low-voltage portion through a distribution transformer. All or part of the power grid 101 may be underground.

The load 103 may be any device that uses, transfers, or distributes electricity in a residential, industrial, or commercial setting, and the load 103 may include more than one device. For example, the load 103 may be a motor, an uninterruptable power supply, or a lighting system. The load 103 may be a device that connects the electrical asset 110 to another portion of the power grid 101. For example, the load 103 may be a recloser or switchgear, another transformer, or a point of common coupling (PCC) that provides an AC bus for more than one discrete load. The load 103 may include one or more distributed energy resources (DER). A DER is an electricity-producing resource and/or a controllable load. Examples of DER include, for example, solar-based energy sources such as, for example, solar panels and solar arrays; wind-based energy sources, such as, for example wind turbines and windmills; combined heat and power plants; rechargeable sources (such as batteries); natural gas-fueled generators; electric vehicles; and controllable loads, such as, for example, some heating, ventilation, air conditioning (HVAC) systems and electric water heaters.

The electrical asset 110 includes a housing 148 that defines an interior space 149. The housing 148 may be any solid, durable material, such as, for example, steel. In some implementations, the housing 148 is sealed and the interior space 149 contains a fluid 146. The fluid 146 may be, for example, a gas such as air, or a liquid such as oil. The fluid 146 may be an electrically insulating liquid, such as, for example, mineral oil, petroleum oil, vegetable oil, and/or synthetic fluids; or an electrically insulating gas.

The thermal management system 170 includes components that control the thermal conditions in the interior space 149. For example, the thermal management system 170 may include pumps, fans, valves, and/or other devices that move the fluid 146 within the interior space 149 and/or move the fluid 146 into the interior space 149 or out of the interior space 149. The thermal management system 170 also includes or communicates with one or more sensors that measure properties of the interior space 149 and/or the fluid 146. The electrical asset 110 also includes a sensor 147t in the interior space 149 and a sensor 147a exterior to the housing 148. The sensors 147t and 147a are thermal sensors that measure, respectively, a temperature in the interior space 149 and an ambient temperature of the environment that surrounds the electrical asset 110. The sensor 147t and/or the sensor 147a may provide data to the thermal management system 170.

The electrical asset 110 includes a winding 112 in the interior space 149. The electrical asset 110 has a first side 115 and a second side 116. In the example of FIG. 1, the first side 115 is electrically connected to an AC power grid 101 and the second side 116 is electrically connected to a load 103. Electrical power from the AC power grid 101 is delivered to the load 103 through the winding 112. In some implementations, the electrical asset 110 is configured to allow bi-directional power flow such that electrical power is also delivered from the load 103 to the grid 101 through the winding 112. In implementations in which the electrical asset 110 is a transformer, the first side 115 and the second side 116 may be referred to as the primary side 115 and the secondary side 116, respectively. The first side 115 may be referred to as an input side 115 and the second side 116 may be referred to as an output side 116.

The winding 112 is made of an electrically conductive material, such as a metal, and is shaped into a coil that includes turns 113. In the example shown in FIG. 1, the winding 112 includes many turns but only one turn is labeled for simplicity. The winding 112 may have any configuration and arrangement that is suitable for the application. For example, the winding 112 may be a copper wire wound in a helix shape or a copper wire wound around a core, such as a ferromagnetic annulus.

The electrical asset 110 also includes insulation 114 (shown with diagonal striped shading in FIG. 1). The insulation 114 electrically insulates the turns 113 from each other and also may electrically insulate the winding 112 from other parts of the electrical asset 110. The insulation 114 also may mechanically support the winding 112 and/or protect the winding 112 from contamination.

The insulation 114 may be directly attached to the winding 112. For example, the insulation 114 may be an electrically insulating coating that is applied to the outer surface of the winding 112. Examples of this type of insulation 114 include, without limitation, resin, epoxy, varnish, and polymer coatings or claddings. The insulation 114 may be an electrically insulating material that is separate from the winding 112 and does not necessarily make contact with the winding 112. Examples of this type of insulation 114 include, without limitation, physical barriers, such as, for example, clamps, boards, and/or spacers made of electrically insulating material, such as, for example, polymer foam or polymer sheets. The insulation 114 may include a combination of such materials. For example, the winding 112 may be coated with a resin and surrounded by an electrically insulating hardened foam.

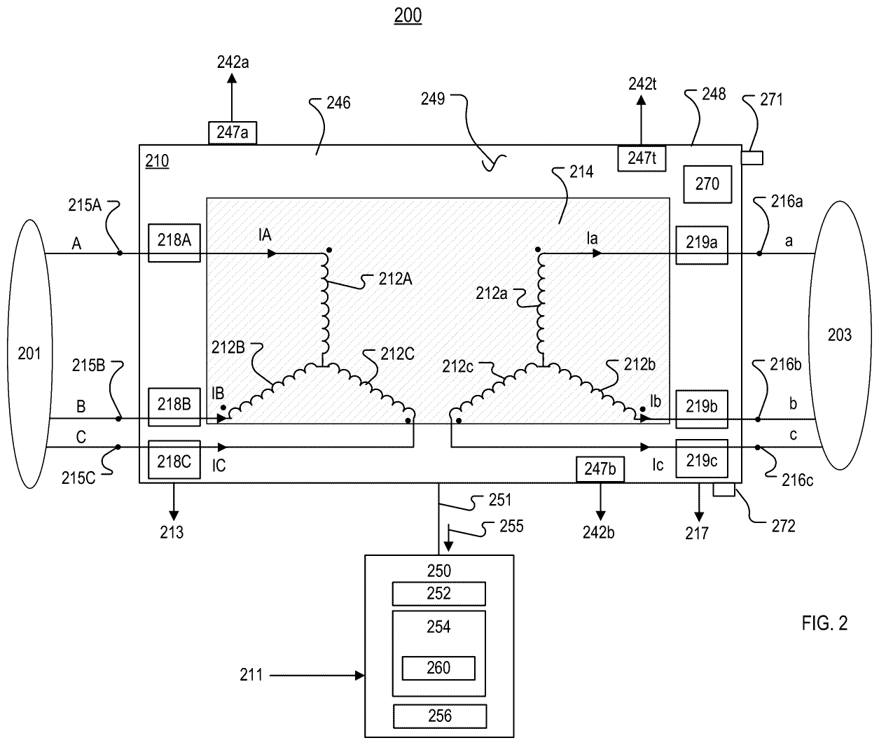

FIG. 2 is a block diagram of a system 200. The system 200 includes an electrical asset 210 and a monitoring system 250. The electrical asset 210 is a three-phase, wye-wye connected transformer that is cooled with a fluid 246, such as, for example, a synthetic or natural oil. Other configurations of the electrical asset 210 are possible, and the three-phase, wye-wye connected transformer is provided as an example.

The transformer 210 includes a housing 248 that defines an interior region 249. The interior region 249 contains the fluid 246. The fluid 246 may be circulated in the interior region 249 by a thermal management system 270. The thermal management system 270 includes any type of device that is capable of moving the fluid 246. For example, the thermal management system 270 may include a pump, a fan, a tube, and/or a combination of such devices. The thermal management system 270 is shown as being in the interior region 249 but all or part of the thermal management system 270 may be outside of the housing 248.

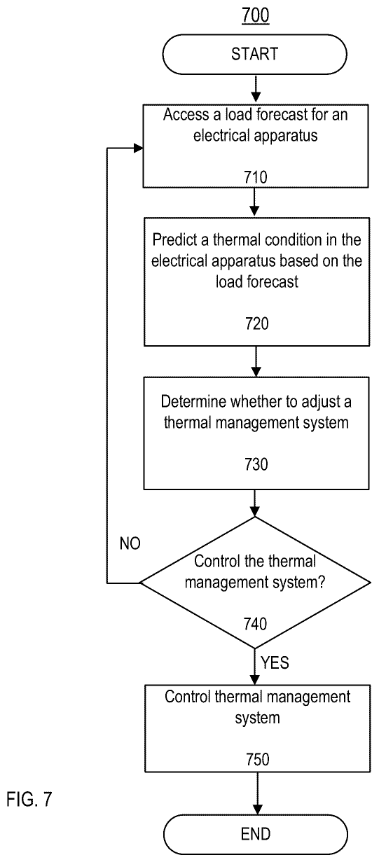

The thermal management system 270 includes an electronic control that acts on the devices of the thermal management system 270 to maintain the temperature of the fluid 246 in accordance with a thermal specification. The electronic control may be implemented as a proportional-integral (PI) controller or by any other control scheme that acts to control the devices such that temperature of the fluid 246 is maintained. The electronic control for the thermal management system 270 may be implemented as part of the monitoring system 250, or the electronic control for the thermal management system 270 may be part of the thermal management system 270 and separate from the monitoring system 250. The control of the thermal management system 270 may be supplemented with the adaptive control approach discussed with respect to FIG. 7.

The transformer 210 also includes a fluid inlet 271 and a fluid outlet 272, both of which are in fluid communication with the interior region 249. The fluid 246 is introduced into the interior region 249 through the fluid inlet 271 and is removed from the interior region 249 through the fluid outlet 272.

The transformer 210 includes thermal sensors 247t, 247b in the interior region 249. The thermal sensors 247t and 247b may be any type of thermal sensor, such as, for example, a thermocouple. The thermal sensor 247t produces a top fluid temperature indication 242t, which is an indication of the temperature of the fluid 246 at or near the inlet 271. A thermal sensor 247a is positioned to measure the ambient temperature in the environment that is exterior to the interior region 249. For example, the thermal sensor 247a may be mounted on the housing 248 or next to the exterior of the housing 248. In some implementations, the thermal sensor 247a is placed in the vicinity of the housing 248. For example, the thermal sensor 247a may be positioned at a distance of 1 meter or more from the exterior of the housing 248. The thermal sensor 247a produces an ambient temperature indication 242a, which is an indication of the temperature of the environment that surrounds the transformer 210. The thermal sensor 247a may be any kind of sensor that is capable of measuring temperature. For example, the thermal sensor 247a may be a thermocouple or a thermometer. In some implementations, the thermal sensor 247a is part of a weather station that produces meteorological data in addition to providing temperature data.

The transformer 210 includes two windings per phase in the interior region 249, as follows: a primary winding 212A and a secondary winding 212a in the A phase, a primary winding 212B and a secondary winding 212b in the B phase, and a primary winding 212C and a secondary winding 212c in the C phase. The transformer 210 also includes electrical insulation 214 (show in gray diagonal striped shading) that protects the primary and secondary windings. The electrical asset 210 has first nodes 215A, 215B, 215C and second nodes 216a, 216b, 216c. The first nodes 215A, 215A, 215C are electrically connected to phases A, B, C of an AC power grid 201. The AC power grid 201 distributes AC current that has a fundamental frequency. The second nodes 216a, 216b, 216c are connected to phases a, b, c of a load 203.

A primary AC current IA, IB, IC flows in each respective first node 215A, 215B, 215C. A secondary AC current Ia, Ib, Ic flows from each respective second node 216a, 216b, 216c. The transformer 210 may be used to step-up (increase) or step-down (decrease) the amplitude of the secondary currents and voltages relative to the primary currents and voltages. When the number of turns in the primary winding 212A, 212B, 212C is greater than the number of turns in the respective secondary winding 212a, 212b, 212c, the amplitude of the secondary current Ia, Ib, Ic is smaller than the amplitude of the respective primary current IA, IB, IC. When the number of turns in the primary winding 212A, 212B, 212C is less than the number of turns in the respective secondary winding 212a, 212b, 212c, the amplitude of the secondary current Ia, Ib, Ic is greater than the amplitude of the respective primary current IA, IB, IC.

The transformer 210 also includes sensors 218A, 218B, 218C that measure one or more electrical properties at the first nodes 215A, 215B, 215C and sensors 219a, 219b, 219c that measure one or more electrical properties at the second nodes 216a, 216b, 216c. For example, each of the sensors 218A, 218B, 218C, 219a, 219b, 219c may measure current, voltage, and/or power at the respective nodes 215A, 215B, 215C, 216a, 216b, 216c. The sensors 218A, 218B, 218C, 219a, 219b, 219c may be any kind of electrical sensor, for example, current transformers (CTs), Rogowski coils, power meters, and/or potential transformers (PT).

The sensors 218A, 218B, 218C produce an indication 213, and the sensors 219a, 219b, 219c produce an indication 217. The indications 213 and 217 include data that represent measured values. For example, the indications 213 and 217 may include sets of numerical values that are each associated with a time stamp, where each set includes three measured values that represent an instantaneous value of an electrical property at one of the first nodes or one of the second nodes. Although the indications 213 and 217 are shown in the example of FIG. 2, other implementations are possible. For example, in some implementations, each sensor 218A, 218B, 218C, 219a, 219b, 219c produces a separate indication.

The monitoring system 250 receives measured data 255 as an input. The measured data 255 includes the indications 213 and 217, the top fluid temperature indication 242t, the bottom fluid temperature indication 242b, and the ambient temperature indication 242a. The monitoring system 250 uses the measured data 255 to predict the overload capability of the transformer 210, to identify potential malfunctions in the transformer 210, and/or to adaptively control the thermal management system 270, as discussed in greater detail with respect to FIGS. 7-10.

The monitoring system 250 includes an electronic processing module 252, an electronic storage 254, and an input/output (I/O) interface 256. The electronic processing module 252 includes one or more electronic processors, each of which may be any type of electronic processor and may or may not include a general purpose central processing unit (CPU), a graphics processing unit (GPU), a microcontroller, a field-programmable gate array (FPGA), Complex Programmable Logic Device (CPLD), and/or an application-specific integrated circuit (ASIC).

The electronic storage 254 is any type of electronic memory that is capable of storing data and instructions in the form of computer programs or software, and the electronic storage 254 may include volatile and/or non-volatile components. The electronic storage 254 and the processing module 252 are coupled such that the processing module 252 can access or read data from and write data to the electronic storage 254.

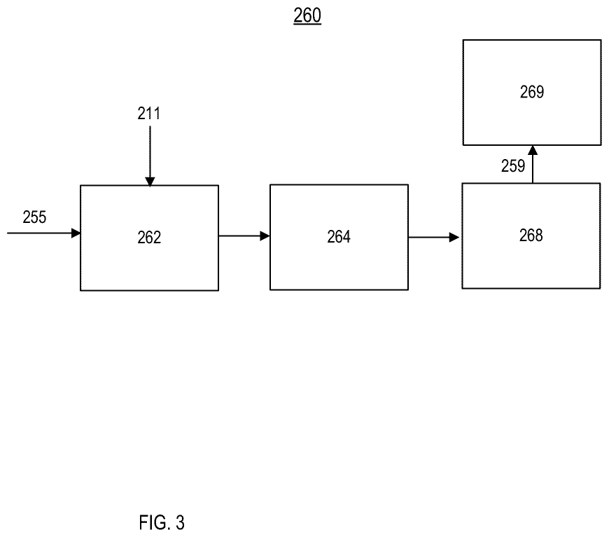

The electronic storage 254 stores executable instructions, for example, as a computer program, logic, or software, that cause the processing module 252 to perform various operations. The electronic storage 254 includes executable instructions that implement a monitoring scheme 260. Details of an example of an implementation of the monitoring scheme 260 are discussed with respect to FIG. 3.

The electronic storage 254 also may store information about the transformer 210. For example, the electronic storage 254 may store nameplate information 211. The nameplate information 211 may include, for example, the rated temperature of the insulation 214 (or the critical hotspot temperature limit); the rated load of the transformer 210; the number of turns on the windings 212A, 212B, 212C, 212a, 212b, 212c; a voltage and/or current rating of the transformer 210; a heat capacity of the material of the windings 212A, 212B, 212C, 212a, 212b, 212c; an identifier or flag that indicates the electrical configuration of the transformer 210; and/or an arrangement of the bushings on the transformer 210. The critical hotspot temperature limit is the highest temperature that the insulation 214 is designed to tolerate. The nameplate information 211 is loaded onto the electronic storage 254 via the I/O interface 256. For example, an operator may enter the nameplate information 211 while the transformer 210 is in the field. In another example, the manufacturer of the transformer 210 may add or edit the nameplate information 211 via the I/O interface 256.

The I/O interface 256 is any interface that allows a human operator, another electronic device, and/or an autonomous process to interact with the monitoring system 250. The I/O interface 256 may include, for example, a display (such as a liquid crystal display (LCD)), a keyboard, audio input and/or output (such as speakers and/or a microphone), visual output (such as lights and/or light emitting diodes (LED)) that are in addition to or instead of the display, a serial or parallel port, a Universal Serial Bus (USB) connection, and/or any type of network interface, such as, for example, Ethernet. The I/O interface 256 also may allow communication without physical contact through, for example, an IEEE 802.11, Bluetooth, or a near-field communication (NFC) connection. The monitoring system 250 may be, for example, operated, configured, modified, or updated through the I/O interface 256.

The I/O interface 256 also may allow the monitoring system 250 to communicate with systems external to and remote from the monitoring system 250 and the transformer 210. For example, the I/O interface 256 may include a communications interface that allows communication between the monitoring system 250 and a remote station (not shown), or between the monitoring system 250 and a separate electrical apparatus (such as another transformer) using, for example, the Supervisory Control and Data Acquisition (SCADA) protocol or another services protocol, such as Secure Shell (SSH) or the Hypertext Transfer Protocol (HTTP). The remote station may be any type of station through which an operator is able to communicate with the monitoring system 250 without making physical contact with the monitoring system 250. For example, the remote station may be a computer-based work station, a smart phone, tablet, or a laptop computer that connects to the monitoring system 250 via a services protocol or a telephone system, or a remote control that connects to the monitoring system 250 via a radio-frequency signal. The monitoring system 250 may communicate information to an external device through the I/O interface 256.

FIG. 3 is a block diagram of the monitoring scheme 260. The monitoring scheme 260 includes a hotspot temperature block 262, a loss of life block 264, an overload capability block 268, and a thermal control block 269. The hotspot temperature block 262 estimates the winding hotspot temperature (OH). The winding hotspot temperature (or hotspot temperature) is an estimate of the highest temperature or maximum temperature of the winding 212. The measured data 255 may include any of the indications 213 and 217, the top fluid temperature indication 242t, the bottom fluid temperature indication 242b, and the ambient temperature indication 242a. The loss of life block 264 estimates the portion of the service life that has passed using the estimate of the hotspot temperature provided by the hotspot temperature block 262. The hotspot temperature block 262 and the loss of life block 264 may be implemented based on the Institute of Electrical and Electronics Engineers (IEEE) C57.91 standard.

The overload capability block 268 produces an estimate 259 of the dynamic overload capability of the transformer 210. The thermal control block 269 adaptively controls the thermal management system 270 based on the dynamic overload capability 259 and/or a user-supplied loading forecast.

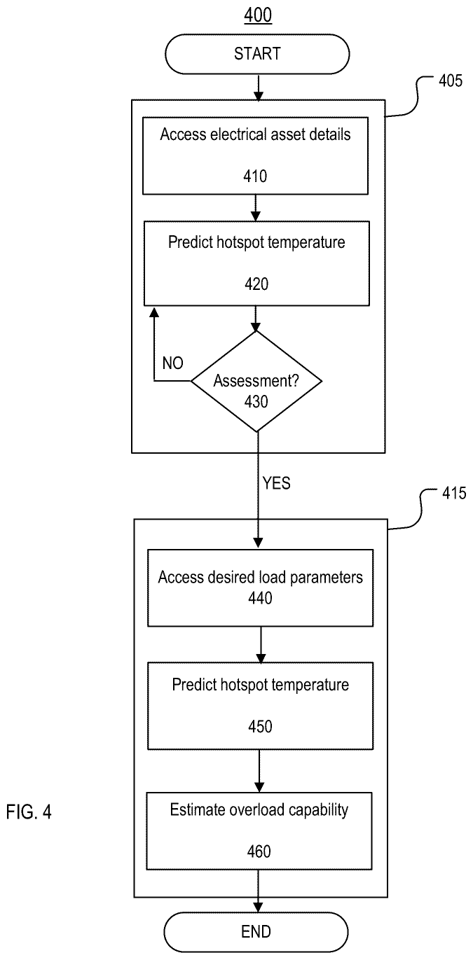

FIG. 4 is a flow chart of a process 400. The process 400 is an example of a process for determining the overload capability of an electrical asset implemented by the overload capability block 268. The process 400 is implemented as a set of machine-executable instructions that are stored on the electronic storage 254. The process 400 runs during operation of the transformer 210. Although the process 400 may be used to determine the overload capability of any electrical asset, the process 400 is discussed with respect to the transformer 210.

The process 400 includes an initialization section 405 and a prediction section 415. The initialization section 405 is performed until the prediction section 415 starts. The prediction section 415 may start in response to a request to estimate the overloading capability of the transformer 210.

In the initialization section 405, one or more details of the transformer 210 are accessed (410). The one or more details of the transformer 210 may include the critical hotspot temperature limit, which is the maximum or rated temperature of the insulation 214, and details about the winding 212, such as the specific heat of the winding and the mass of the winding 212. The critical hotspot temperature limit may be accessed from the electronic storage 254 and/or from the I/O interface 256. The critical hotspot temperature limit may be part of the nameplate information 211. The electrical asset details also include the measured data 255.

The hotspot temperature is predicted (420) based on the accessed details of the transformer. The hotspot temperature at a particular time is predicted or estimated using various equations that are set forth in the IEEE 57.91 Standard, Annex G. The hotspot temperature at a particular time (time t2 in the example below) is estimated using Equation 1:

$${Θ}_{H , 2} = \frac{{Q}_{gen , HS} - {Q}_{Lost , HS} + {M}_{W} {C}_{PW} {Θ}_{H , 1}}{{M}_{W} {C}_{PW}} , \qquad Equation ( 1 )$$

where Θ_{H,2} is the hotspot temperature at time t2; Θ_{H,1} is the hotspot temperature at time t1 (where t1 is a time that occurred prior to time t2); M_{W} is the mass of the winding 212; C_{PW} is the specific heat of the winding 212; Q_{gen,HS} is heat generated at the hotspot temperature; and Q_{lost,HS} is the heat load at the hotspot temperature. The Q_{gen,HS} is estimated as shown in Equation (2):

$${Q}_{gen , HS} = {K}^{2} [ {P}_{HS} {K}_{HS} + \frac{{P}_{EHS}}{{K}_{HS}} ] Δ t , \qquad Equation ( 2 )$$

where K is the load factor (or the present load divided by the rated load), P_{HS} is the copper loss at rated load and rated winding hotspot temperature, K_{HS} is the temperature correction for losses at the hotspot location, P_{EHS} is the eddy current loss at rated load and rated winding hotspot temperature, and Δt is the time difference between t2 and t1. The time difference between t2 and t1 is also referred to as the time step. The value of K is calculated by determining the present load using the indication 217 (which is the measured current output by the transformer 210) and dividing the calculated present load by the rated load of the transformer 210. The value of Δt may be stored on the electronic storage 254. The initial value of the prior hotspot temperature (Θ_{H,1}) when the transformer 210 is first operated at time=0 may be set to 0 or to a predefined value that is stored on the electronic storage 254.

The value of Q_{lost,HS} is estimated as shown in Equation (3):

$$QLost , HS = {{[ \frac{{Θ}_{H , 1} - {Θ}_{w 0}}{{Θ}_{H , R} - {Θ}_{w 0 , R}} ]}^{1.25} [ \frac{{μ}_{HS , R}}{{μ}_{HS , 1}} ]}^{0.25} ( {P}_{HS} + {P}_{EHS} ) Δ t , \qquad Equation ( 3 )$$

where Θ_{H,R} is the hotspot temperature at rated load; μ_{HS,1} is the viscosity of the fluid 246 for the hotspot temperature at the previous time t1; μ_{HS,R} is the viscosity of the fluid 246 for the hotspot temperature at the rated load; Θ_{WO} is the temperature of the fluid 246 adjacent to the winding hotspot at the current time instant (time t2 in this example); and Θ_{WO,R} is the temperature of the fluid 246 adjacent to the winding hotspot at the rated load. The value of K_{HS} used in Equation (2) is estimated as shown in Equation (4):

$${K}_{HS} = \frac{{Θ}_{H , 1} + {Θ}_{K}}{{Θ}_{H , R} + {Θ}_{K}} , \qquad Equation ( 4 )$$

The values of P_{HS} and P_{EHS}, which are both used in Equation (2), are estimated as shown in Equation (5) and Equation (6):

$${P}_{HS} = ( \frac{{Θ}_{H , R} + {Θ}_{k}}{{Θ}_{W , R} + {Θ}_{k}} ) {P}_{w} \qquad Equation ( 5 )$$

$$and$$

$${P}_{EHS} = {E}_{HS} {P}_{HS} , \qquad Equation ( 6 )$$

where Θ_{W,R} is the average temperature of the winding 212 at the rated load, Θₖ is the temperature factor for resistance correction, Pw is the material loss of the winding 212 at the rated load, and E_{HS} is the eddy loss at the winding hotspot location, per unit of material loss.

As shown in Equation (3), the value of Q_{LOST,HS} also depends on the temperature of the fluid 246 adjacent to the winding hotspot (Θ_{WO}). Estimation of the fluid 246 temperature adjacent to the winding hotspot (Θ_{WO}) is discussed next with respect to Equations (7) to (12). The ambient temperature measured by the sensor 247a is used to determine the heat lost by the fluid 246 due to the ambient conditions outside of the housing 248:

$$QLOST , 0 = {[ \frac{{Θ}_{AO , 1} - {Θ}_{A 1}}{{Θ}_{AO , R} - {Θ}_{A , R}} ]}^{\frac{1}{y}} {P}_{T} Δ t , \qquad Equation ( 7 )$$

where Θ_{AO,R} is the average temperature of the fluid 246 at the rated load; Θ_{AO,1} is the average temperature of the fluid 246 at the prior time t1; Θ_{A,1} is the ambient temperature at the prior time t1; Θ_{A,R} is the rated ambient temperature at kVA base for the load cycle; PT is the total loss at the rated load in watts; and y is the exponent of average fluid rise with heat loss. The exponent y is 0.8 for an oil natural air natural (ONAN) transformer, and 0.9 for an oil natural air forced (ONAF) or oil forced air forced (OFAF) transformer, and 1.0 for an oil directed air forced (ODAF) transformer.

The heat lost to ambient (Q_{LOST,O}) is used to estimate the average temperature of the fluid 246 at the time t2 (Θ_{AO,2}) by:

$${Θ}_{A O , 2} = \frac{{Q}_{LOST , W} + {Q}_{S} + {Q}_{C} - {Q}_{LOST , O} + ( \sum {MC}_{P} ) {Θ}_{AO , 1}}{\sum {MC}_{P}} , \qquad Equation ( 8 )$$

where Q_{LOST,W} is the heat lost by the winding in watts-minute; Q_{S} is the heat generated by stray losses in watts-minute; Q_{C} is the heat generated by the core in watts-minute; Q_{LOST,O} is determined in Equation (7); and the summation of M_{CP} is the total mass times the specific heat of the fluid 246, the housing 248, and the core in watts-minute.

The temperature rise of the fluid 246 at the top of the housing 248 (as measured by the sensor 247t) over the bottom of the housing 248 (as measured by the sensor 247b) is given by:

$${ΔΘ}_{T / B} = ( {Θ}_{TO} - {Θ}_{BO} ) = [ \frac{{Q}_{LOST , O}}{{P}_{T} Δ t} ] ( {Θ}_{TO , R} - {Θ}_{BO , R} ) , \qquad Equation ( 9 )$$

where Θ_{TO} is the temperature of the fluid 246 as measured by the sensor 247t; Θ_{BO} is the temperature of the fluid 246 as measured by the sensor 247b; Θ_{TO,R} is the top fluid 246 temperature at the rated load; and Θ_{BO,R} is the bottom fluid 246 temperature at the rated load. Rearranging and combining terms to provide an estimate of the bottom fluid 246 temperature:

$${Θ}_{BO} = {Θ}_{AO} - \frac{{ΔΘ}_{T / B}}{2} . \qquad Equation ( 10 )$$

The bottom fluid 246 temperature is used to find the temperature of the fluid 246 adjacent to the winding (Θ_{WO}) based on:

ΔΘ_{WO/BO}=H_{HS}(Θ_{TDO}−Θ_{BO}) Equation (11),

where ΔΘ_{WO/BO} is the temperature rise of the fluid 246 at the winding hotspot over the bottom fluid 246 temperature; H_{HS} is the per unit of winding height to hotspot location; and Θ_{TDO} is the fluid temperature at the inlet 271. The temperature of the fluid 246 adjacent to the winding is determined by:

Θ_{WO}=Θ_{BO}+ΔΘ_{WO/BO} Equation (12).

The temperature of the fluid 246 adjacent to the winding hotspot is used to calculate the heat loss at the hotspot location (Q_{LOST,NS}) as shown in Equation (3), and the heat loss at the hotspot location (Q_{LOST,NS}) is used to estimate the hotspot temperature (Θ_{H,2}) as shown in Equation (1).

After each estimation of the hotspot temperature (Θ_{H,2}), the process 400 advances to (430) to determine whether a condition to perform a load capability assessment has been met. In other words, the hotspot temperature Θ_{H,2} is repeatedly estimated at each time step using (420) during operation of the transformer 210 until the condition to perform a load capability assessment is met.

The condition for performing a load capability assessment may be an elapsed time since the transformer 210 was commissioned or first operated, or the condition may be receipt of a command to perform the load capability assessment. In implementations in which the condition is time-based, the occurrence of the condition may be determined by comparing the elapsed time since the previous load capability assessment or from the beginning of operation of the transformer 210 to a time value stored on the electronic storage 254.

The time value may be input by a user or operator of the transformer 210. For example, the time value may be a numerical value that represents the number of hours that the transformer 210 should be operated before performing the load capability assessment. The numerical value may be, for example, 15 hours, 30 hours, or 100 hours. The numerical value may represent the time elapsed since the installation or initial use of the transformer 210 or the time elapsed since the most recent load capability assessment.

In some implementations, the condition for performing a load capability assessment occurs upon receipt of an external command instead of or in addition to the expiration of a pre-set amount of operating time. For example, an operator or end user of the transformer 210 may enter a request to perform a load capability assessment through the I/O interface 256. The request may be a request to begin the load capability assessment immediately or to begin the load capability assessment after a specified amount of time.

The above conditions for performing a load capability assessment are provided as examples, and other conditions are possible. In some implementations, the condition for performing a load capability assessment is based on the measured data 255. For example, the condition for performing a load capability assessment may occur when the measured current in the indication 217 exceeds the rated current for the transformer for more than a specified amount of time.

If the condition for performing a load capability assessment is not met or has not occurred, the process 400 returns to (420) and predicts the hotspot temperature at the next time step. If the condition for performing a load capability assessment is met, the process 400 continues to the prediction section (415) to perform the load capability assessment.

The desired load parameters are accessed (440). The desired load parameters are parameters that indicate a load factor for operating the transformer 210. The desired load parameters also may include a time duration for operating the transformer at a particular load factor. The desired load parameters may be stored on the electronic storage 254 or entered through the I/O interface 256.

The hotspot temperature is predicted for each load factor in the desired load parameters (450). The hotspot temperature is predicted using Equations (1) to (12). The initial value of (ΘH,1) is the value of (ΘH,2) that was determined at (420). The value of K in Equation (2) is set to each of the load factors in the desired load parameters, such that Qgen,HS is determined for each load factor for the time step Δt. The determined values of Qgen,HS are then used in Equation (1) to predict the hotspot temperature ΘH,2 that would occur if the transformer was operated at the desired load factor for the amount of time represented by Δt. The calculations represented by Equations (1) to (12) may be repeated to predict the hotspot temperature for each load factor for additional time steps, thus predicting the hotspot temperature further into the future. The predicted hotspot temperatures are stored on the electronic storage 254. For example, the estimated hotspot temperature for each load factor at each time step may be stored as a numerical vector or a matrix. The hotspot temperature for each load factor at times that are between the time steps may be estimated by interpolation.

The overload capability of the transformer 210 is estimated (460). The overload capability is estimated based on the hotspot temperature predictions made in (450). For example, the amount of time that the transformer 210 can be operated at a particular load factor is determined by finding the time at which the hotspot temperature for that load factor exceeds the critical hotspot temperature or the specified hotspot temperature. In this example, the overload capability is output as an amount of time for a known or desired load factor. In another example, the overload capability is provided as a maximum load factor at which the transformer 210 may be operated before reaching the critical hotspot temperature or specified hotspot temperature. The overload capability 259 may be presented at the I/O interface 256, provided to the thermal control block 269, saved on the electronic storage 254, and/or transmitted to a remote device as the output 259 (FIG. 3).

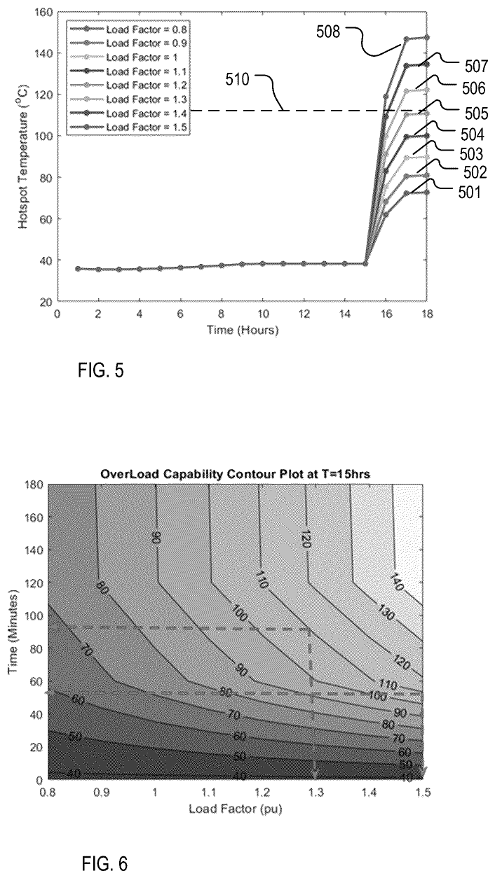

In some implementations, the estimated overload capability (the output 259) is presented graphically at the I/O interface 256 and/or at a remote device. FIGS. 5 and 6 show examples of graphical overload capability computed in (460). FIGS. 5 and 6 show simulated data for a transformer rated at 2.6 MVA, 11 kV/433V with a specified hotspot temperature of 110 degrees Celsius (° C.), which is labeled as 510 in FIG. 5. In this example, the desired load parameters were a range of load factors between 0.8 per unit load (pu) and 1.5 pu in 0.1 increments, and the overload capability was requested 15 hours after the transformer began operating. The load factor is a value that represents a ratio between the current or observed load and the rated load. Thus, a load factor of 1 pu indicates that the transformer 210 is operating at the rated load, a load factor of less than 1 pu indicates that the transformer 210 is operating at less than the rated load, and a load factor of more than 1 indicates that the transformer 210 is operating at more than the rated load.

FIG. 5 shows predicted hotspot temperature in Celsius (° C.) as a function of time in hours for each of the range of load factors in a vector K′=0.8, 0.9, 1.0, 1.1, 1.2, 1.3, 1.4, 1.5. The predicted hotspot temperatures for the load factors in the vector K′ as a function of time are labeled in FIG. 5 as 501, 502, 503, 504, 505, 506, 507, 508, respectively. The predicted hotspot temperature shown in FIG. 5 was determined from Equations (1) through (12), and the load factor (K) was varied in Equation (2) to obtain the predicted hotspot temperature for each load factor. The overload capability condition was met at 15 hours after the transformer 210 began operation, the time step Δt was 1 hour, and the predicted hotspot temperature was computed for three subsequent times: 16 hours, 17 hours, and 18 hours.

As shown in FIG. 5, the predicted hotspot temperature increased as the load factor increased. The load factors of 1.3 and less did not exceed the specified hotspot temperature between 15 and 18 hours. Thus, the simulated transformer can be operated at load factors of 1.3 or less for 3 hours beginning at 15 hours. The process 400 may output the data shown in FIG. 5 as a graph, as a summary of the overload capability (for example, a text or audible message that states that the simulated transformer can be operated at a load factor of up to 1.3 for 3 hours), or the data shown in FIG. 5 may be saved to the electronic storage 254 for later analysis.

FIG. 6 is a contour plot of overload capability for the same simulated transformer, with time (minutes) versus load factor, with the contour lines being the predicted hotspot temperature in ° C. The contour plot in FIG. 6 was generated based on data generated for FIG. 5. The specified hotspot temperature was 110° C. Thus, the contour for the 110° C. is a boundary for safe overloading of the simulated transformer and may be used to determine the overload capability for the simulated transformer. The simulated transformer can be operated safely at any of the load factors and times to the left and below the 110° C. contour line.

FIG. 7 is a flow chart of a process 700 performed by the thermal control block 269. The process 700 is an example of a process for adaptively controlling the thermal management system 270. The process 700 may be implemented as a collection of machine-executable instructions or a computer program stored on the electronic storage 254. The process 700 is discussed with respect to the transformer 210 but may be applied to other electrical apparatuses. For example, the process 700 may be applied to the electrical apparatus 110 (FIG. 1).

A load forecast for the transformer 210 is accessed (710). The load forecast may be accessed from the electronic storage 254 or through the I/O interface 256. The load forecast is any type of prediction of the future loading of the transformer 210, and the load forecast specifies a time at which the loading is expected to occur. For example, the load forecast may be based on the estimate of the dynamic overload capability 259 generated by the process 400. To provide a specific example, the load forecast may be a maximum load factor at which the transformer 210 may be operated for a given period of time and a beginning and/or ending time that specifies when the transformer 210 will be operated at the maximum load factor. In another example, the load forecast may be a load factor specified by an operator or user of the transformer 210 and a time period over which the transformer 210 will be operated at the specified load factor. In yet another example, the load forecast may be more than one load factor, each associated with a time period during which the transformer 210 will be operated at the particular load factor.

A thermal condition in the transformer 210 is predicted for the loading factor and times specified in the load forecast (720). The thermal condition may be a temperature in the interior 249 or a change of temperature in the interior 249. For example, a temperature of a component in the interior 249, a hotspot temperature, and/or a temperature of the fluid 246 may be predicted based on the load forecast. The hotspot temperature (Θ_{H}) at the future times associated with the load forecast may be predicted using the load factor (K) in the load forecast and Equations (1)-(12) discussed above.

In another example, the predicted change in the temperature 242t (the temperature of the fluid 246 measured by the sensor 247t near the inlet 271) may be predicted using Equation (13):

$${ΔΘ}_{TO} = {{ΔΘ}_{TO , R} [ \frac{( {K}_{U}^{2} R + 1 )}{( R + 1 )} ]}^{n} , \qquad Equation ( 13 )$$

where Δ_{TO} is the predicted change in the temperature 242t over a single time step when the transformer 210 is operated at a load factor K, Δ_{TO,R} is the change in the temperature 242t over the time step when the transformer is operated at the rated load, n is an empirically derived and pre-known constant associated with the transformer 210, and R is the ratio of load loss at rated load to no-load loss for the transformer 210.

The thermal condition is predicted for all of the times specified in the load forecast. For example, if the load forecast specifies three different loading factors, each for a distinct future time period, then the thermal condition is predicted for each of the three future time periods. The predicted thermal condition may be stored on the electronic storage 254 as a two-dimensional array of values, where the array includes predicted thermal conditions (for example, predicted hotspot temperatures) and an associated future time for each predicted thermal condition.

The predicted thermal condition is analyzed to determine whether to adjust the thermal management system 270 (730). For example, the predicted thermal condition may be compared to a thermal specification that is stored on the electronic storage 254 to determine whether to control the thermal management system 270 (740). The thermal specification may include particular threshold values and/or a range of acceptable operating conditions. The thermal management system 270 is controlled when one or more of the predicted thermal conditions is outside of the range of acceptable operating conditions and/or exceeds a threshold. For example, the range of acceptable operating conditions may include a range of hotspot temperatures that are associated with efficient operation of the transformer 210. A predicted hotspot temperature that is above the highest hotspot temperature in the specification or below the predicted hotspot temperature is outside of the range of acceptable operating conditions. In another example, the specification includes a threshold that indicates a maximum change in the temperature of the fluid 246 near the inlet 271.

If the comparison of one or more of the predicted thermal conditions indicates that the thermal conditions in the transformer 210 will be outside of the thermal specification, then the thermal management system 270 is controlled (750). Controlling the thermal management system 270 may include activating the thermal management system 270 or deactivating the thermal management system 270. For example, if the predicted thermal conditions indicate that in two hours, the temperature 242t of the fluid 246 near the inlet 271 will exceed the upper limit of acceptable temperatures, in one hour, the control system 270 may act on the thermal control system 270 to reduce the temperature of the fluid 246 such that the temperature of the fluid 246 does not exceed the upper limit of acceptable temperatures. For example, the thermal control block 269 may include instructions that act on the thermal management system 270 to activate a pump such that the fluid 246 is circulated more quickly and/or additional fluid 246 that is cooler is introduced into the interior 249. By acting to prevent the temperature of the fluid 246 from exceeding the upper limit of acceptable temperatures, the thermal control block 269 allows for more efficient and effective operation of the thermal management system 270.

The thermal control block 269 continues to monitor the temperature 242t and continues to control the thermal management system 270 such that the temperature of the fluid 246 near the inlet 271 remains within the thermal specification.

In another example, the predicted thermal conditions indicate that the temperature of the fluid 246 near the inlet 271 will be below the minimum temperature in a range of acceptable temperatures at a future time (tf). Low temperature conditions such as this may occur, for example, during a period of light loading or loading of the transformer 210. The thermal control block 269 may turn off the thermal management system 270 before or at the future time (tf). Turning off the thermal management system 270 saves energy and prolongs the life of the thermal management system 270. In implementations in which the thermal control block 269 turns off the thermal management system 270, the thermal control block 269 reactivates the thermal management system 270 prior to a time when the thermal condition is predicted to come back into the range of acceptable temperature. Furthermore, while the thermal management system 270 is off, the thermal control block 269 continues to monitor the temperature 242t and switches the thermal management system 270 back on if the temperature 242t exceeds the minimum temperature in the range of acceptable temperatures earlier than expected.

The adaptive control of the thermal management system 270 provided by the thermal control block 269 prolongs the life of the thermal management system 270 and the transformer 210. The adaptive control also allows promotes effective and efficient operation of the thermal management system 270 and the transformer 210.

After the thermal control block 269 has controlled the thermal management system 270 for the forecasted load, the process 700 ends or returns to (710) to access another load forecast.

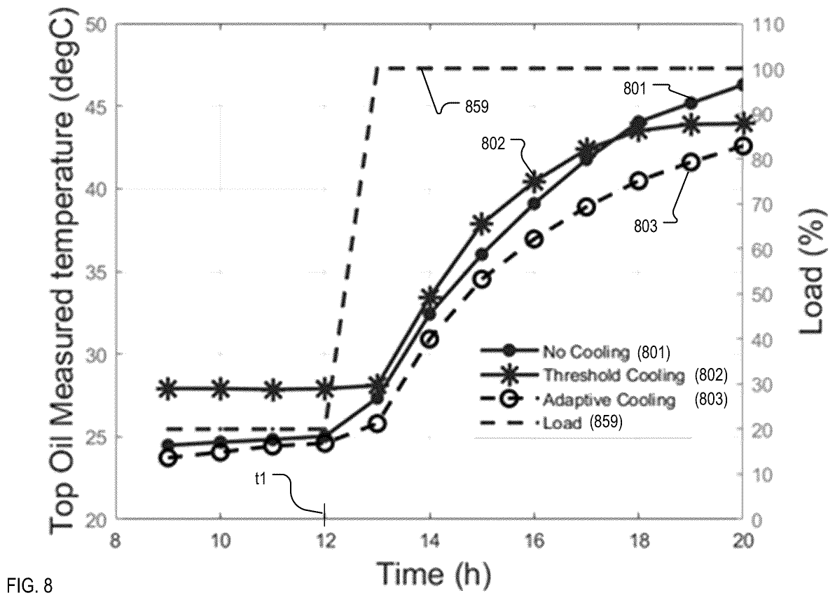

FIG. 8 shows simulated data as a function of time (in hours). FIG. 8 includes a load forecast 859 (dashed line without markers) for the transformer 210. The load forecast 859 is a forecasted percentage of rated load as a function of time, with the percentage of rated load shown on the right y-axis. FIG. 8 also shows the temperature 242t as a function of time for three scenarios during the same time scale as the load forecast 859: no action by the thermal management system 270 (the curve with the solid circle markers labeled 801), traditional P-I thermal control of the thermal management system 270 with a set point of 37° C. (the curve with the asterisk markers labeled 802), and adaptive cooling by the thermal control block 269 (the curve with the open circle markers labeled 803).

As shown in FIG. 8, the load forecast shows that the transformer 210 will be operated at 20% of rated load between about hour 9 and a time t1 (about hour 12). At the time t1, the transformer 210 will be operated at the rated load. As shown in FIG. 8, the adaptive cooling approach implemented by the thermal control block 269 provides superior performance as compared to no thermal control and traditional set point-based control. For example, the adaptive cooling approach maintains a lower temperature 242t over time. By maintaining the fluid 246 at a lower temperature, the thermal control block 269 allows the transformer 210 to operate more efficiently.

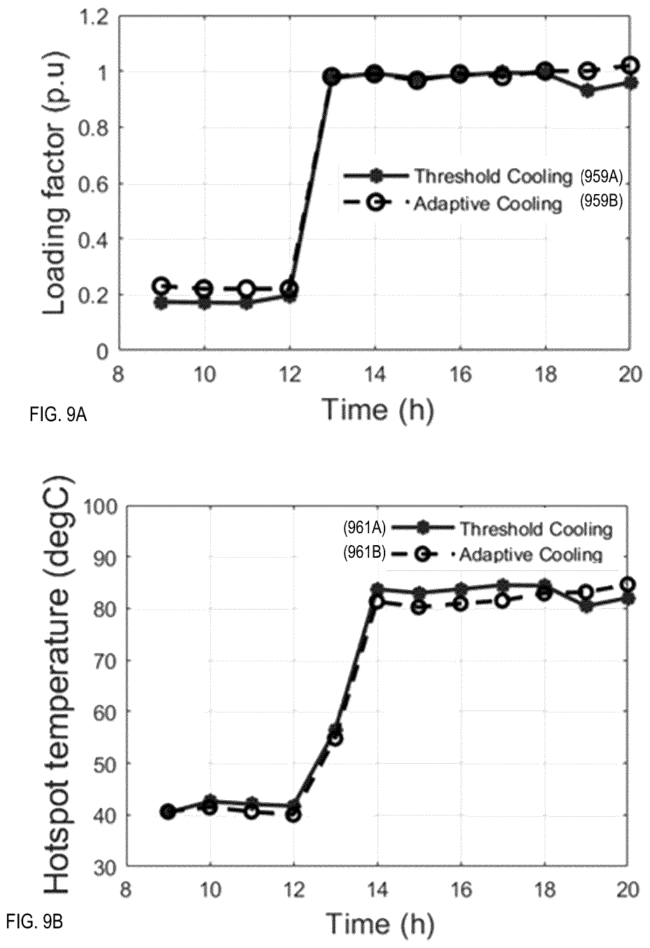

FIGS. 9A and 9B show additional simulated data as a function of time. Each of FIGS. 9A and 9B has the same time scale as FIG. 8. FIG. 9A shows per-unit (pu) load 959A (the curve with solid circle markers) and 959B (the curve with open circle markers) for the transformer 210 as a function of time. The load 959A is for an implementation in which the thermal management system 270 is controlled using a legacy approach based on a fixed threshold. The load 959B is for an implementation in which the thermal management system 270 is controlled using the adaptive approach 700 discussed with respect to FIG. 7.

FIG. 9B shows the estimated hotspot temperature as a function of time for the threshold-based cooling (961A) and the adaptive cooling (961B). To quantify the effectiveness of the cooling approaches, the equivalent aging of the transformer 210 was estimated over 24 hours. The equivalent aging is determined based on:

$$FAA = e [ \frac{B}{{{HST}_{rated}}^{+ 273}} - \frac{B}{{{HST}_{rated}}^{+ 273}} ] , \qquad Equation ( 14 )$$

where FAA is the aging acceleration factor at Δtₙ time interval, HST_{rated} is the rated hotspot temperature for the transformer 210 (for example, 110° C.), HST_{estimated} is the estimated hotspot temperature (shown in FIG. 9B as 961A and 961B), and B is the aging rate constant (for example, 15000). The equivalent aging (EQA) is determined by:

$$EQA = \frac{{\sum }_{n = 1}^{N} {FAA}_{n} Δ {t}_{n}}{{\sum }_{n = 1}^{N} Δ {t}_{n}} , \qquad Equation ( 15 )$$

where n is index of the time interval Δt, N is total time interval (for example, 24 hours), and FAAₙ is aging acceleration factor at Δtₙ time interval as determined by Equation (14). The equivalent aging (EQA) over in 24 hours was calculated for the transformer 210 as load 959A according to the threshold-based approach and as load 959B according to the adaptive cooling approach. For the legacy threshold-based cooling, the estimated equivalent aging (EQA) was 0.7416 and for the adaptive cooling the EQA was 0.6597. Thus, the adaptive cooling approach lead to a reduction in aging of about 11%.

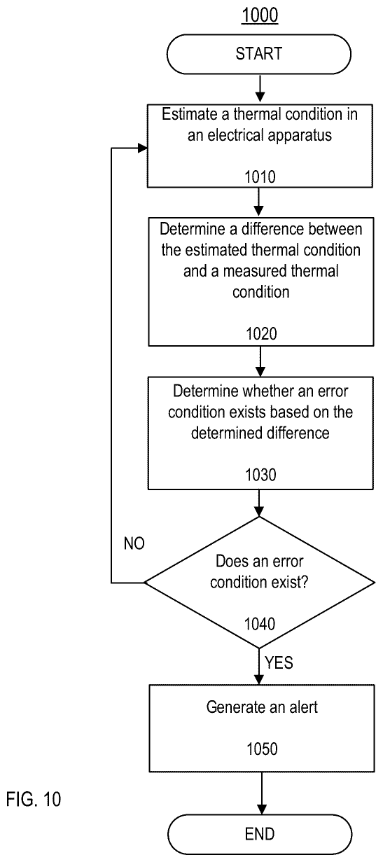

FIG. 10 is a flow chart of a process 1000. The process 1000 is an example of an anomaly detection process for detecting error conditions in an electrical apparatus based on thermal data. The process 1000 may be implemented as a collection of machine-executable instructions or a computer program stored on the electronic storage 254. The process 1000 is discussed with respect to the transformer 210 but may be used with other electrical assets, such as, for example, the electrical asset 110 of FIG. 1.

A thermal condition is estimated in the transformer 210 (1010). For example, the temperature of the fluid 246 near the inlet 271 may be estimated based on the IEEE C57.91 standard as shown in Equation (16):

Θ_{TO}=Θ_{A}+ΔΘ_{TO} Equation (16),

where Θ_{TO} is the estimated top oil temperature (the estimate of the temperature of the fluid 246 near the inlet 271); Θ_{A} is the ambient temperature, as provided by the sensor 247a or forecasted weather data), and ΔΘ_{TO} is the fluid 246 temperature rise over ambient for a time step estimated by Equation (13).

A difference between the estimated thermal condition and a measurement of that thermal condition is determined (1020). Continuing the example above in which the thermal condition is the temperature of the fluid 246 near the inlet, the measurement of the thermal condition is the temperature measurement 242t from the sensor 247t at the time step used to estimate the fluid 246 temperature rise over ambient (ΔΘ_{TO}) in Equation (16).

Whether or not an error condition exists in the transformer 210 is determined based on the difference (1030). The estimate of the thermal condition is close to the measured or actual thermal condition when the transformer 210 is operating as expected. When an error condition, such as a malfunction or other anomaly, exists the estimate becomes less accurate and the difference between the estimated and measured values of the thermal condition diverge. Examples of specific malfunctions that cause the estimated and measured values to diverge include pump or valve failure, blocking of the inlet 271 and/or outlet 272, and failure of the monitoring system 250. Thus, the magnitude of the difference between the estimated and measured thermal conditions provides an indication of whether or not an error condition exists in the transformer 210.

To determine whether an error condition exists, the difference is compared to an error threshold. The error threshold may be stored on the electronic storage 254. The error threshold may expressed in any form. For example, the error threshold may be a value that, if exceeded by the magnitude of the difference, indicates the existence of an error condition. In another example, the error threshold may be expressed as a percent difference between the estimated and measured values that, if exceeded, indicates that an error condition exists in the transformer 210.

If the difference indicates that an error condition exists (1040), an alert is generated (1050). The alert may be in any form. For example, the alert may be a visible alert or an audible alert. The alert may be provided to a remote device, such as, for example, a computer or remote workstation and/or the alert may be presented at the I/O interface 256. In some implementations, an alert is only generated if the difference has indicated that an error condition exists for a finite period of time. In other words, in some implementations, the alert is only generated if the difference that exceeds the threshold persists over a period of time. This may help to avoid or reduce false alerts and alerts for self-correcting transient conditions. After generating the alert, the process 1000 ends.

If the difference does not indicate that an error condition exists (1040), the process 1000 returns to (1010) or ends.

These and other implementations are within the scope of the claims.

What is claimed is:

1. An electrical apparatus comprising:
a housing that defines an interior space;
an active portion in the interior space, the active portion comprising one or more electrically conductive coils;
a fluid in the interior; and
a control system configured to:
determine a difference between a measured temperature of the fluid and an estimated temperature of the fluid; and
determine whether a performance condition exists based on the difference.

2. The electrical apparatus of claim 1, wherein, to determine whether a performance condition exists, the control system is configured to compare the difference to a threshold.

3. The electrical apparatus of claim 2, wherein the control system determines that a performance condition exists when an absolute value of the difference is equal to or exceeds the threshold.

4. The electrical apparatus of claim 1, further comprising a temperature sensor configured to measure the temperature of the fluid.

5. The electrical apparatus of claim 1, further comprising a cooling system configured to circulate the fluid in the interior space, and wherein the cooling system comprises an inlet and an outlet, the temperature sensor is configured to measure the temperature of the fluid at the inlet, and the estimated temperature of the fluid is an estimated temperature of the fluid at the inlet.

6. The electrical apparatus of claim 1, wherein each of the one or more coils is wrapped around a magnetic core.

7. The electrical apparatus of claim 6, wherein each of the one or more coils is wrapped around a separate magnetic core.

8. An electrical apparatus comprising:
a housing that defines an interior space;
an active portion in the interior space, the active portion comprising one or more electrically conductive coils;
a cooling system configured to remove heat from the active portion; and
a control system configured to:
predict a future temperature in the interior space based on a load forecast; and
determine whether to control the cooling system based on the future temperature.

9. The electrical apparatus of claim 8, further comprising a fluid in the interior space, and wherein the cooling system is configured to control the fluid to thereby remove heat from the active portion.

10. The electrical apparatus of claim 8, wherein the cooling system comprises one or more devices configured to cause the fluid to move in the interior space.

11. The electrical apparatus of claim 8, wherein the cooling system comprises an inlet and an outlet, the fluid is configured to flow into the interior space through the inlet, and the fluid is configured to flow out of the interior space through the outlet.

12. The electrical apparatus of claim 8, wherein the load forecast comprises a load factor and a time during which the load factor occurs.

13. The electrical apparatus of claim 9, wherein the control system is configured to control the control system by activating the cooling system or to deactivating the control system.

14. The electrical apparatus of claim 13, wherein the control system is further configured to compare the future temperature to a temperature specification.

15. The electrical apparatus of claim 14, wherein the control system activates the cooling system if the future temperature exceeds the temperature specification.

16. The electrical apparatus of claim 15, wherein the control system determines a time at which to activate the cooling system if the future temperature exceeds the temperature specification.
